(19) United States
(12) Patent Application Publication
(10) Pub. No.: US 2025/0367933 A1
(43) Pub. Date: Dec. 4, 2025

(54) SYSTEM AND METHOD FOR PRESERVING INKJET OPERATIONAL STATUS FOLLOWING PRINTER OPERATIONS THAT EXPOSE INKJETS TO DRYING

(71) Applicant: Xerox Corporation, Norwalk, CT (US)

(72) Inventors: Seemit Praharaj, Webster, NY (US); Jason M. LeFevre, Penfield, NY (US); Douglas K. Herrmann, Webster, NY (US); Anthony S. Condello, Webster, NY (US); Jorge A. Alvarez, Webster, NY (US)

(21) Appl. No.: 18/731,719

(22) Filed: Jun. 3, 2024

(51) Int. Cl. B41J 2/165; B41J 2/045

(52) U.S. Cl. CPC B41J 2/16552; B41J 2/04566; B41J 2/16526; B41J 2/16579

(57) ABSTRACT

An inkjet printer includes a printhead maintenance station that emits a mist of fluid onto the faceplate of a printhead mated to a receptacle within the printhead maintenance station. A controller is configured to operate one or more nozzles within the receptacle at predetermined time intervals to maintain a film of a fluid mist on the printhead mated to the receptacle. Alternatively, the controller is configured to monitor a humidity level within the receptacle and operate one or more nozzles within the receptacle to maintain the humidity level within a predetermined range. When more than one nozzle is provided in the receptacle of either embodiment, the controller is further configured to operate the nozzles independently of one another.

### TECHNICAL FIELD

This disclosure relates generally to devices that produce ink images on media, and more particularly, to the preservation of inkjet operational status during periods of inkjet inactivity.

### BACKGROUND

Inkjet imaging devices, also known as inkjet printers, eject liquid ink from printheads to form images on an image receiving surface. The printheads include a plurality of inkjets that are arranged in an array. Each inkjet has a thermal or piezoelectric actuator that is coupled to a printhead controller. The printhead controller generates firing signals that correspond to digital data content that define the images. The actuators in the printheads respond to the firing signals by expanding into an ink chamber fluidly connected to a nozzle to eject ink drops from the nozzle onto the image receiving surface to form an ink image that corresponds to the digital image content used to generate the firing signals. The image receiving surface is usually a continuous web of media material or a series of media sheets.

Inkjet printers used for producing color images typically include multiple printhead modules. Each printhead module includes one or more printheads that typically eject a single color of ink. In a typical inkjet color printer, four printhead modules are positioned in a process direction with each printhead module ejecting a different color of ink. The four ink colors most frequently used are cyan, magenta, yellow, and black. The common nomenclature for such printers is CMYK color printers. Some CMYK color printers have two printhead modules that print each color of ink. The printhead modules that print the same color of ink are offset from each other by one-half of the distance between adjacent inkjets in the cross-process direction to double the number of pixels per inch to increase the density of a line of the color of ink ejected by the printheads in the two modules. As used in this document, the term “process direction” means the direction of movement of the image receiving surface as it passes the printheads in the printer and the term “cross-process direction” means a direction that is perpendicular to the process direction in the plane of the image receiving surface.

Inkjets, especially those in printheads that eject aqueous inks, need to fire regularly to help prevent the ink in the nozzles from drying. The media onto which the ink images are printed are not always the same width as the width of a printhead module in the cross-process direction. When media having a width that is less than the width of the printhead module in the cross-process direction are printed, the inkjets on one end or the other or both ends of the printhead module, depending on the positioning of the media on the transport path, in the cross-process direction are not operated as no media passes these inkjets. Depending upon the time required to print such a print job, ink may dry in these inkjets or, at a minimum, the viscosity of the ink in these nozzles may increase. Consequently, a printhead maintenance operation is desirable for replacing the higher viscosity ink or for removing dried ink from nozzles or the faceplate of a printhead.

To maintain the operational status of the inkjets, the printhead modules are moved from positions opposite the path of the image receiving substrates to printhead maintenance stations where a printhead maintenance operation is performed. One such maintenance operation is purging. Purging a printhead means a pressurized gas or liquid is applied to the ink supply chambers within a printhead to force ink from the chambers into all of the nozzles of a printhead so ink is emitted from the nozzles onto the faceplate. One or more wipers are then moved across the faceplate to remove the purged ink from the faceplate into a waste ink receptacle. Of course, the ink emitted from nozzles that were operational prior to the maintenance operation is wasted since it cannot be used for printing ink images. Thus, inkjet printers would benefit from being able to maintain the operational status of inkjets in a printhead selectively.

### SUMMARY

An inkjet printer includes a printhead maintenance station that is configured to maintain the operational status of inkjets in a printhead selectively. The inkjet printer includes at least one printhead module; and a printhead maintenance station, the printhead maintenance station including a first receptacle, the first receptacle being configured to mate with a faceplate of a first printhead; a first nozzle in the first receptacle, the first nozzle being configured to emit a first fluid mist onto the faceplate mated to the first receptacle; and a controller configured to operate the first nozzle at predetermined time intervals to maintain a film of the first fluid mist on the faceplate mated to the first receptacle.

An alternative embodiment of an inkjet printer that is configured to maintain the operational status of inkjets in a printhead selectively includes at least one printhead module; and a printhead maintenance station having a first receptacle, the first receptacle being configured to mate with a faceplate of a first printhead; a first nozzle in the first receptacle, the first nozzle being configured to emit a first fluid mist onto the faceplate mated to the first receptacle; a first humidity sensor within the first receptacle, the first humidity sensor being configured to generate a signal corresponding to a humidity level within the first receptacle; and a controller operatively connected to the first humidity sensor. The controller is configured to compare the signal generated by the first humidity sensor to a predetermined range of humidity levels that correspond to a drying rate of a liquid ejected by the first printhead; and supply a solvent to the first nozzle to maintain the humidity level within the first receptacle within the predetermined range of humidity levels that correspond to a drying rate of a liquid ejected by the first printhead.

A method of operating a printhead maintenance station maintains the operational status of inkjets in a printhead selectively. The method includes operating a first nozzle in a first receptacle at predetermined time intervals to maintain a film of a first fluid mist on a faceplate of a first printhead mated to the first receptacle.

### BRIEF DESCRIPTION OF THE DRAWINGS

The foregoing aspects and other features of an inkjet printer, a printhead maintenance station, and an inkjet printer operational method that maintains the operational status of inkjets in a printhead selectively are explained in the following description, taken in connection with the accompanying drawings.

FIG. 1 is a schematic drawing of a color inkjet printer that maintains the operational status of inkjets in a printhead selectively.

FIG. 2 depicts the print zone of the printer shown in FIG. 1 and the printhead maintenance stations positioned adjacent to the print zone.

FIG. 3A is a perspective view of a printhead maintenance station used in the printer of FIG. 1 and FIG. 3B is a cross-sectional view of the printhead maintenance station of FIG. 3A.

FIG. 4 is a flow diagram for operating the printhead maintenance station of FIG. 3B.

### DETAILED DESCRIPTION

For a general understanding of the environment for the inkjet printer, printhead maintenance station, and the inkjet printer operational method disclosed herein as well as the details for the inkjet printer, the printhead maintenance station and the printhead maintenance station operational method, reference is made to the drawings. In the drawings, like reference numerals have been used throughout to designate like elements. As used herein, the word “printer” encompasses any apparatus that ejects ink drops onto different types of media to form ink images.

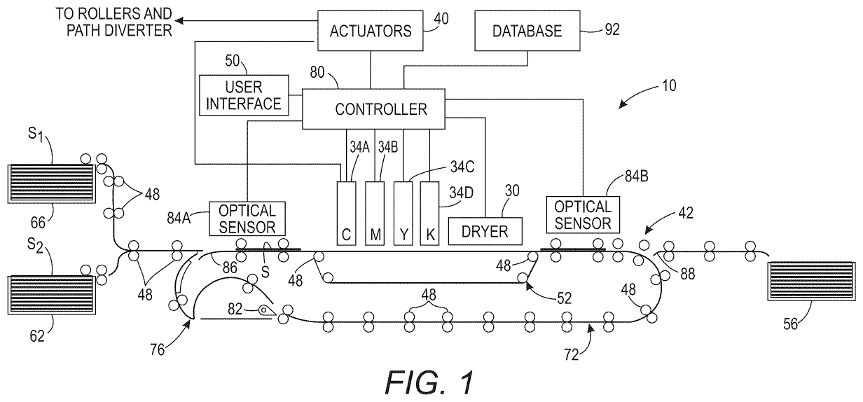

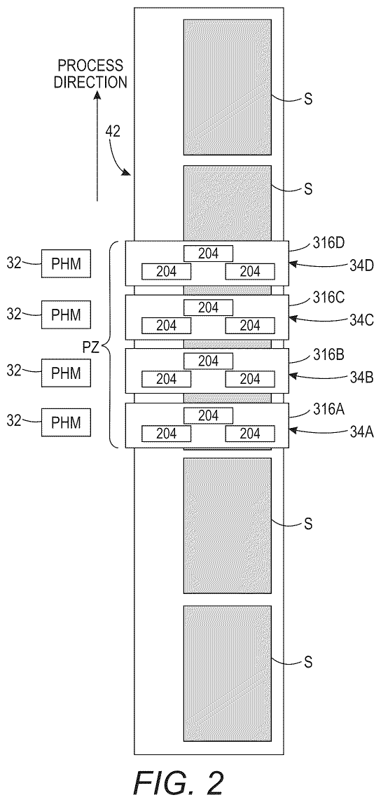

FIG. 1 depicts a high-speed color inkjet printer 10 that maintains the operational status of inkjets in a printhead selectively. As illustrated, the printer 10 is a printer that directly forms an ink image on a surface of a media sheet stripped from one of the supplies of media sheets S₁ or S₂ and the sheets S are moved through the printer 10 by the controller 80 operating one or more of the actuators 40 that are operatively connected to rollers or to at least one driving roller of conveyor 52 that comprise a portion of the media transport 42 that passes through the print zone PZ (shown in FIG. 2) of the printer. In one embodiment, each printhead module has only one printhead that has a width that corresponds to a width of the widest media in the cross-process direction that can be printed by the printer. In other embodiments, the printhead modules have a plurality of printheads with each printhead having a width that is less than a width of the widest media in the cross-process direction that the printer can print. In these modules, the printheads are arranged in an array of staggered printheads or a linear array of printheads that abut one another in the cross-process direction to enable media wider than a single printhead to be printed. Additionally, the printheads within a module or between printheads in different modules can also be interlaced so the density of the drops ejected by the printheads in the cross-process direction can be greater than the smallest spacing between the inkjets in a printhead in the cross-process direction. Although printer 10 is depicted with only two supplies of media sheets, the printer can be configured with three or more sheet supplies, each containing a different type or size of media.

The print zone PZ in the printer 10 of FIG. 1 is shown in FIG. 2. The print zone PZ has a length in the process direction commensurate with the distance from the first inkjets that a sheet passes in the process direction to the last inkjets that a sheet passes in the process direction and it has a width that is the maximum distance between the most outboard inkjets on opposite sides of the print zone that are directly across from one another in the cross-process direction. Each printhead module 34A, 34B, 34C, and 34D shown in FIG. 2 has three printheads 204 mounted to one of the printhead carrier plates 316A, 316B, 316C, and 316D, respectively. Adjacent to the print zone PZ are four printhead maintenance stations (PHM) 32. During printing operations, conditions for performance of printhead maintenance operations can be detected so printhead operations can be performed. One detectable condition for performing printhead maintenance operations requires the generation of image data of test patterns printed during a print job or of the printed images. Image quality metrics can be determined from the image data of the printed ink images and test patterns and compared to one or more thresholds. When the metrics degrade to values below the thresholds, printhead maintenance operations are performed to maintain at least some of the inkjets in a printhead. Other detectable conditions include empirically determined values, such as chronological time intervals between printhead maintenance operations, a number of images printed between printhead maintenance operations, and the like. Additionally, operators can use the user interface 50 to perform printhead maintenance operations, either in a precautionary manner or in accordance with an organizational preventive maintenance schedule.

To perform printhead maintenance operations, printing operations are halted and the printhead modules are moved from the print zone PZ to the adjacent printhead maintenance stations 32. The inkjet maintenance devices in the printhead maintenance station are operated as described in more detail below to maintain the operational status of the inkjets. These operations can remove ink from nozzles that have a higher viscosity than the optimal level or by returning dried ink in a nozzle or on a printhead faceplate to a liquid state. As used in this document, the term “print zone” means an area of a media transport opposite the printheads of an inkjet printer when the printheads are in position for printing ink images on media.

With further reference to FIG. 1, a printed image exits the print zone of printer 10 and passes under an image dryer 30 after the ink image is printed on a sheet S. As used in this document, the term “print zone” means an area of a media transport opposite the printheads of an inkjet printer. The image dryer 30 can include an infrared heater, a heated air blower, air returns, or combinations of these components to heat the ink image and at least partially fix an ink image to the sheet S. An infrared heater applies infrared heat to the printed image on the surface of the sheet S to evaporate water and solvent from the ink. The heated air blower directs heated air using a fan or other pressurized source of air over the ink to supplement the evaporation of the water and solvent from the ink. The air is then collected and evacuated by air returns to reduce the interference of the dryer air flow with other components in the printer.

Controller 80 operates at least one of the actuators 40 to rotate a pivoting member at position 88 to either direct a sheet to receptacle 56 or to return path 72. A sheet S is moved by the rotation of rollers along the return path 72 in a direction opposite to the direction of movement in the process direction past the printheads. Pivoting member 82 is operated by the controller 80 to either direct the sheet along a curved portion of the return path 72 into inverter 76 so the sheet is turned over for duplex printing or along the straight portion of the return path 72. When the sheet follows the straight portion, the inverter 76 is bypassed and the side of the sheet previously printed can be printed again. The controller operates one of the actuators 40 to move the pivoting member 82 clockwise to direct a sheet into the inverter 76 and counterclockwise to bypass the inverter. Regardless of whether the substrate is inverted or not, it merges into the job stream being carried by the media transport 42 when controller 80 operates another actuator 40 to rotate pivoting member 86 to provide ingress of a sheet S from return path 72 to the job stream entering the print zone.

As further shown in FIG. 1, the printed media sheets S not diverted to the duplex path 72 are carried by the media transport to the sheet receptacle 56 in which they are be collected. Before the printed sheets reach the receptacle 56, they pass by an optical sensor 84B. The optical sensor 84B generates image data of the printed sheets and this image data is analyzed by the controller 80 to detect streakiness in the printed images on the media sheets of a print job. Additionally, sheets that are printed with test pattern images are printed at intervals during the print job. Image data of these test pattern images generated by optical sensor 84B are analyzed by the controller 80 to determine which inkjets, if any, that were operated to eject ink into the test pattern did in fact do so, and if an inkjet did eject an ink drop whether the drop landed at its intended position with an appropriate mass. Any inkjet not ejecting an ink drop it was supposed to eject or ejecting a drop not having the correct mass or landing at an errant position is called an inoperative inkjet in this document. The controller can store data identifying the inoperative inkjets in database 92 operatively connected to the controller 80. These sheets printed with the test patterns are sometimes called run-time missing inkjet (RTMJ) sheets and these sheets are discarded from the output of the print job. A user can operate the user interface 50 to obtain reports displayed on the interface that identify the number of inoperative inkjets and the printheads in which the inoperative inkjets are located. For sheets that are not inverted and merged into the job stream by the operation of pivoting member 86, optical sensor 84A generates image data of the printed side and the controller 80 uses that image data to register the sheets and to operate the ejectors in the printhead to further print images on the previously printed sheet sides. The optical sensors 84A and 84B can be a digital camera, an array of LEDs and photodetectors, or other devices configured to generate image data of a passing surface. While FIG. 1 shows the printed sheets as being collected in the sheet receptacle 56, they can be directed to other processing stations (not shown) that perform tasks such as folding, collating, binding, and stapling of the media sheets.

In some less robust printers, such as monochrome printers, conditions for performing printhead maintenance operations do not require the generation of image data with an optical sensor. As noted previously, these printers can use the measurement of a time interval between printhead maintenance operations or the number of images printed since a last maintenance operation or the number of images printed in predetermined span of time to detect a condition favorable for performing a printhead maintenance operation. An example of this latter condition occurs when a portion of a printhead prints a number of images that is less than some requisite minimum of images that help maintain the inkjets in that portion of the printhead. Monochrome inkjet printers include those printers that have as few as a single printhead that in some cases are as wide as the media transport in the cross-process direction and in other cases, the multiple printheads that are less than the width of the media transport are arranged in a staggered or linear array to cover the width of the media transport in the cross-process direction. Alternatively, a single printhead that has a width of the media transport in the cross-process direction can be scanned across the media in the cross-process direction to print ink images in a known manner.

Operation and control of the various subsystems, components and functions of the machine or printer 10 are performed with the aid of a controller or electronic subsystem (ESS) 80. The ESS or controller 80 is operatively connected to the components of the printhead modules 34A-34D (and thus the printheads), the actuators 40, and the dryer 30. The ESS or controller 80, for example, is a self-contained computer having a central processor unit (CPU) with electronic data storage, and a display or user interface (UI) 50. The ESS or controller 80, for example, includes a sensor input and control circuit as well as a pixel placement and control circuit. In addition, the CPU reads, captures, prepares, and manages the image data flow between image input sources, such as a scanning system or an online or a work station connection (not shown), and the printhead modules 34A-34D. As such, the ESS or controller 80 is the main multi-tasking processor for operating and controlling all of the other machine subsystems and functions, including the printing process.

The controller 80 can be implemented with general or specialized programmable processors that execute programmed instructions. The instructions and data required to perform the programmed functions can be stored in non-transitory computer readable medium associated with the processors or controllers. The processors, their memories, and interface circuitry configure the controllers to perform the operations described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image content data for an image to be produced are sent to the controller 80 from either a scanning system or an online or work station connection for processing and generation of the printhead control signals output to the printhead modules 34A-34D. Along with the image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “image content data” means digital data that identifies an ink image to be printed on a media sheet.

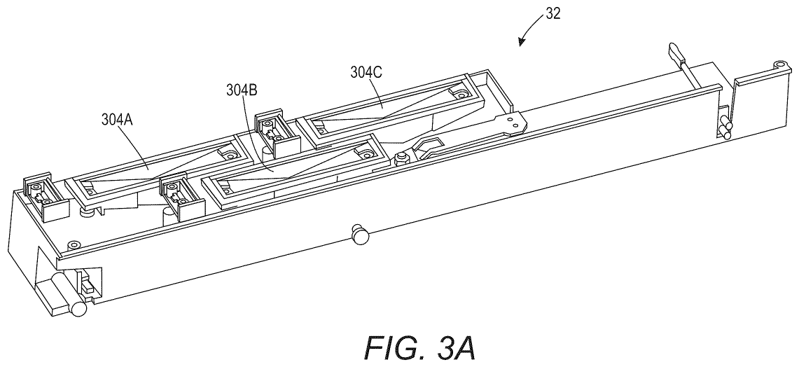

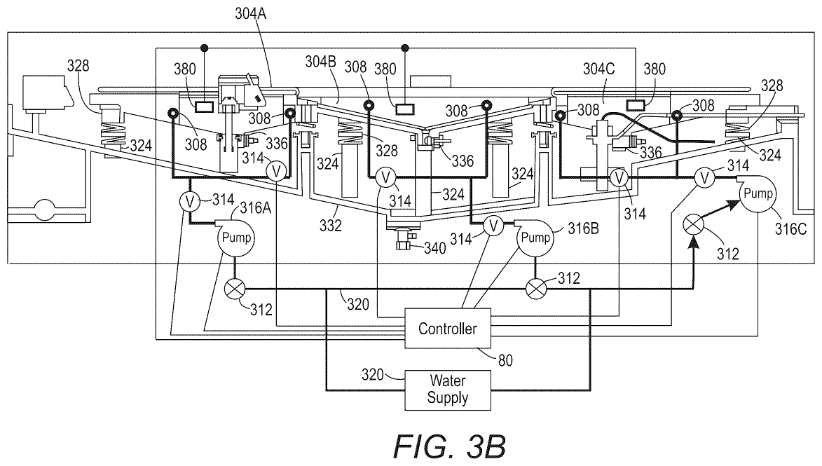

A perspective view of a printhead maintenance station 32 is shown in FIG. 3A. The station 32 includes three receptacles 304A, 304B, and 304C for mating with one of the printheads 204 in a printhead module 316A, 316B, 316C, or 316D. The station 32 can be configured to slide under the printhead module after the printhead module has been lifted with respect to the print zone so the printhead module can be lowered onto the receptacles to seal the faceplates of the printheads against the receptacles. When printing operations are to resume, the printhead module is lifted and the printhead maintenance station 32 returns to the home position shown in FIG. 2 and FIG. 3A. Alternatively, the printhead module can be configured to move from a position over the print zone shown in FIG. 2 to a position over the station 32 for selective maintenance of inkjets in the printheads and then returned to the print zone to resume printing operations.

A cross-sectional view of the printhead maintenance station 32 of FIG. 3A is shown in FIG. 3B. Pillars 324 extend from a bottom floor 332 of the station 32 towards a floor of a receptacle. A biasing member 328 is positioned about an upper end of each pillar 32 to resiliently support the receptacle when a printhead is pressed against a seal around the receptacle. Each receptacle 304A, 304B, and 304C includes a drain valve 336 that can be operated by the controller 80 to release accumulated fluid from a receptacle and direct it to the bottom floor 332 of the station. The floor 332 is slanted to direct the released fluid to a station drain valve 340 and the controller 80 operates this drain valve to empty fluid from the station 32. Within each receptacle at least one humidity sensor 380 is provided. The signals from the humidity sensors 380 are operatively connected to the controller 80 and these signals are used by the controller to implement a closed feedback loop to maintain the humidity level in a receptacle at an optimal level for keeping a film of liquid solvent on the faceplate of the printhead mated to the receptacle.

With further reference to FIG. 3B, a solvent supply 320 is fluidly connected to a conduit that extends between the three pumps 316A, 316B, and 316C. While the figure shows the solvent supply as being a water supply, the solvent supply can be a reservoir containing other ink solvents, such as printhead cleaning fluid. Alternatively, both a water supply and a cleaning fluid supply can be fluidly connected to the conduits connecting the pumps with a valve between each supply and the conduit to the pumps to supply the different fluids selectively to the conduit. Additionally, the solvent supply can include a heater so the solvent can be heated prior to delivery to a nozzle. Heating the solvent is useful for providing solvent at a temperature that is greater than a temperature of a printhead to enhance condensation of the mist on the printhead. Each pump is fluidly connected to the solvent supply through a valve 312 that is operatively connected to the controller 80 so the valves 312 can be operated by the controller 80 to supply the pumps 316A, 316B, and 316C independently with water or fluid. Within each receptacle 304A, 304B, and 304C is a pair of nozzles 308. In each receptacle, the conduit connecting the nozzles 308 includes a pair of valves 314 and the valves 314 in all of the receptacles are operatively connected to the controller 80 so the valves 314 can be operated by the controller to connect the nozzles 308 within a receptacle to a corresponding pump and supply the nozzles 308 independently. This configuration enables only a portion of a printhead faceplate opposite a nozzle to be independently misted. Alternatively, the mist produced by the nozzles 308 can be supplied from an external source of solvent and the controller 80 operates one or more valves to connect the external source to the conduits leading to the nozzles 308 within the receptacles.

Controller 80 is configured with programmed instructions stored on non-transitory computer-readable media that the controller executes to control the pumps 316A, 316B, and 316C and the valves 312 and 314 independently of one another. Thus, the pumps can be independently supplied with water and fluid and the pumps independently operated to pressurize the water or cleaning fluid independently and the valves 314 are operated to enable water or fluid to be pressurized by a pump to reach either one or both nozzles 308 within a receptacle. The nozzles are configured to generate a mist with the pressurized water or fluid to dissolve dried ink, return higher viscosity ink to a more optimal level, or maintain ink within the inkjets within a range about the optimal level during periods of printhead inactivity. The provision of multiple nozzles 308 with a receptacle enable a portion of a printhead faceplate opposite the nozzle and within the nozzles of the printhead faceplate to be maintained. This independent control of the pumps 316A, 316B, and 316C and the valves 312 and 314 enables the controller 80 to control the printhead maintenance station to dissolve dried ink in the printheads and even portions of a printhead selectively. The misting water or fluid does not require the waste of ink, which is the case with inkjet purges, nor does it require that all printheads and all inkjets of a printhead to be serviced during a restoration operation.

Importantly, controller 80 is also configured with programmed instructions stored on non-transitory computer-readable media that the controller executes to maintain the humidity within each receptacle in a predetermined humidity range that corresponds to a rate for drying the fluid in the nozzles or on the faceplate of a printhead. This humidity control is necessary because the different types and colors of fluid ejected by printheads in a printer dry at different rates. To achieve this humidity range control, the controller commences operation of the nozzles 308 to apply a mist of liquid solvent to the portion of the printheads in the vicinity of the nozzles. The signals from the humidity sensors within a receptacle are monitored and compared to a range of target humidity levels for the type of liquid ejected by the printhead mated to the receptacle. The term “type of liquid” is used because the system described in this document can be used to maintain printheads that eject different types and colors of aqueous ink, primers used to condition media for printing, special inks containing metal particles, clear coat inks, and the like. The controller 80 operates the valves, pumps, and drains within the system of FIG. 3B to maintain a film of liquid on the faceplate of a printhead and within the nozzles of the printhead. The humidity ranges used for control of the pumps, valves, and drains correspond to a level of liquid film desirable for keeping the type of liquid ejected by the printhead in the nozzles and on the faceplates at an appropriate viscosity level. Alternatively, the pumps and valves can be operated at predetermined time intervals to maintain a film of liquid on the faceplate of the printhead and within the nozzles of the printhead. For example, in one embodiment, the controller operates the pumps and valves at three seconds on and three seconds off for this purpose.

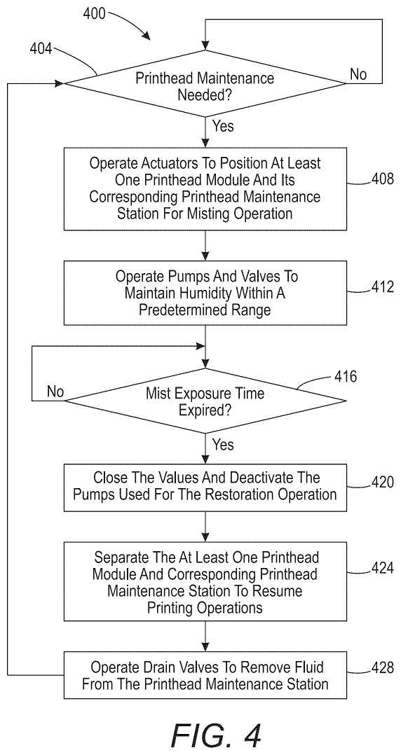

A process 400 for operating the inkjet printer of FIG. 1 to maintain the operational status of inkjets in the inkjet printer selectively is shown in FIG. 4. In the description of the process, statements that the process is performing some task or function refers to a controller or general purpose processor executing programmed instructions stored in non-transitory computer readable medium operatively connected to the controller or processor to manipulate data or to operate one or more components in the printer to perform the task or function. The controller 80 noted above can be such a controller or processor. Alternatively, the controller can be implemented with more than one processor and associated circuitry and components, each of which is configured to perform one or more tasks or functions described herein. Additionally, the steps of the method may be performed in any feasible chronological order, regardless of the order shown in the figures or the order in which the processing is described.

The process 400 of FIG. 4 begins by detecting a condition indicative that at least one printhead requires a printhead maintenance operation to maintain the inkjets in the printhead (block 404). As noted above, a number of parameters can be used for this condition detection. These detected conditions can also be used to identify the nozzles within a receptacle that need to be operated during a maintenance operation. The process 400 continues by operating actuators to position the at least one printhead module and its corresponding printhead maintenance station opposite one another (block 408). Only the pumps and valves needed to supply the nozzles identified previously to maintain a predetermined humidity range within a receptacle are operated (block 412). After an appropriate time for exposure to the mist has expired (block 416), the valves are closed and the pumps deactivated (block 420). The at least one printhead module and corresponding printhead maintenance station are separated so printing operations can resume (block 424) and the drain valves used in the printhead maintenance station(s) are operated to remove fluid from the station(s) (block 428). Additionally, provided the printheads of a particular printhead or printhead module are not required for printing operations, this process can be performed on a printhead or printhead module while printing operations are ongoing. Also, as noted previously, during the time for exposing a printhead to the mist, the pumps and valves can be operated a predetermined time intervals to maintain a film of a fluid mist on a printhead face instead of using signals generated by humidity sensors within the receptacles.

It will be appreciated that variants of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. An inkjet printer comprising:
at least one printhead module; and
a printhead maintenance station, the printhead maintenance station including:
a first receptacle, the first receptacle being configured to mate with a faceplate of a first printhead;
a first nozzle in the first receptacle, the first nozzle being configured to emit a first fluid mist onto the faceplate mated to the first receptacle; and
a controller configured to operate the first nozzle at predetermined time intervals to maintain a film of the first fluid mist on the faceplate mated to the first receptacle.

2. The inkjet printer of claim 1, the printhead maintenance station further comprising:
an actuator operatively connected to the first printhead, the actuator being configured to move the first printhead between a first position where the faceplate of the first printhead does not mate with the first receptacle and a second position where the faceplate of the first printhead mates with the first receptacle; and
the controller is operatively connected to the actuator, the controller being further configured to:
detect a condition indicative of maintenance needed for the first printhead; and
operate the actuator to move the first printhead to the second position.

3. The inkjet printer of claim 2 wherein the condition is a number of inoperative inkjets in the first printhead.

4. The inkjet printer of claim 2 wherein the condition is an image metric that is outside a predetermined threshold.

5. The inkjet printer of claim 2 wherein the condition is a number of inkjet images printed by the first printhead.

6. The inkjet printer of claim 2 wherein the condition is an expiration of a time interval between printhead maintenance operations.

7. The inkjet printer of claim 2 wherein the condition is a number of ink images printed within a predetermined period of time.

8. The inkjet printer of claim 1 further comprising:
a second nozzle in the first receptacle, the second nozzle in the first receptacle being configured to emit a second fluid mist onto the faceplate of the first printhead mated to the first receptacle; and
a controller being configured to operate the second nozzle in the first receptacle independently of the first nozzle in the first receptacle.

9. The inkjet printer of claim 1, the printhead maintenance station further comprising:
a second receptacle, the second receptacle being configured to mate with a faceplate of a second printhead;
a first nozzle in the second receptacle, the first nozzle in the second receptacle being configured to emit a first fluid mist onto the faceplate mated to the second receptacle; and
the controller being further configured to operate the first nozzle in the second receptacle at the predetermined time intervals independently of the first nozzle in the first receptacle.

10. The inkjet printer of claim 9, the printhead maintenance station further comprising:
a second nozzle in the second receptacle, the second nozzle in the second receptacle being configured to emit a second fluid mist onto the faceplate of the printhead mated to the second receptacle; and
the controller being further configured to operate the second nozzle in the second receptacle at the predetermined time intervals independently of the first nozzle in the second receptacle.

11. An inkjet printer comprising:
at least one printhead module; and
a printhead maintenance station having:
a first receptacle, the first receptacle being configured to mate with a faceplate of a first printhead;
a first nozzle in the first receptacle, the first nozzle being configured to emit a first fluid mist onto the faceplate mated to the first receptacle;
a first humidity sensor within the first receptacle, the first humidity sensor being configured to generate a signal corresponding to a humidity level within the first receptacle; and
a controller operatively connected to the first humidity sensor, the controller being configured to:
compare the signal generated by the first humidity sensor to a predetermined range of humidity levels that correspond to a drying rate of a liquid ejected by the first printhead; and
supply a solvent to the first nozzle to maintain the humidity level within the first receptacle within the predetermined range of humidity levels that correspond to a drying rate of a liquid ejected by the first printhead.

12. The inkjet printer of claim 11, the printhead maintenance station further comprising:
a second receptacle, the second receptacle being configured to mate with a faceplate of a second printhead;
a first nozzle in the second receptacle, the first nozzle in the second receptacle being configured to emit a first fluid mist onto the faceplate mated to the second receptacle;
a second humidity sensor within the second receptacle, the second humidity sensor being configured to generate a signal corresponding to a humidity level within the second receptacle; and
the controller operatively connected to the second humidity sensor, the controller being configured to:
compare the signal generated by the second humidity sensor to a predetermined range of humidity levels that correspond to a drying rate of a liquid ejected by the second printhead; and
supply a solvent to the first nozzle in the second receptacle to maintain the humidity level within the second receptacle within the predetermined range of humidity levels that correspond to a drying rate of a liquid ejected by the second printhead.

13. The inkjet printer of claim 12, the printhead maintenance station further comprising:
an actuator operatively connected to the first printhead, the actuator being configured to move the first printhead between a first position where the faceplate of the first printhead does not mate with the first receptacle and a second position where the faceplate of the first printhead mates with the first receptacle; and
the controller is operatively connected to the actuator, the controller being further configured to:
detect a condition indicative of maintenance needed for the first printhead; and
operate the actuator to move the first printhead to the second position.

14. The inkjet printer of claim 13 wherein the condition is one of a number of inoperative inkjets in the first printhead, an image metric that is outside a predetermined threshold, a number of inkjet images printed by the first printhead, an expiration of a time interval between printhead maintenance operations, a number of ink images printed within a predetermined period of time.

15. A method of operating an inkjet printer comprising:
operating a first nozzle in a first receptacle at predetermined time intervals to maintain a film of a first fluid mist on a faceplate of a first printhead mated to the first receptacle.

16. The method of claim 15 further comprising:
detecting a condition indicative of maintenance needed for the first printhead; and
operating an actuator to move the first printhead from a first position where the faceplate of the first printhead does not mate with the first receptacle and a second position where the faceplate of the first printhead mates with the first receptacle to the second position.

17. The method of claim 16 wherein the condition is one of a number of inoperative inkjets in the first printhead, an image metric that is outside a predetermined threshold, a number of inkjet images printed by the first printhead, an expiration of a time interval between printhead maintenance operations, and a number of ink images printed within a predetermined period of time.

18. The method of claim 15 further comprising:
operating a second nozzle in the first receptacle independently of the first nozzle in the first receptacle.

19. The method of claim 15 further comprising:
operating a first nozzle in a second receptacle at the predetermined time intervals to maintain a film of a second fluid mist on a faceplate of a second printhead mated to the second receptacle independently of the first nozzle in the first receptacle.

20. The method of claim 19 further comprising:
operating a second nozzle in the second receptacle at the predetermined time intervals independently of the first nozzle in the second receptacle.
